(19) United States
(12) Patent Application Publication
(10) Pub. No.: US 2008/0000589 A1
(43) Pub. Date: Jan. 3, 2008

(54) Adhesive tape joining apparatus

(75) Inventor: Osamu Degawa, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: Nitto Denko Corporation, Ibaraki-shi (JP)

(21) Appl. No.: 11/819,239

(22) Filed: Jun. 26, 2007

(30) Foreign Application Priority Data
Jun. 28, 2006 (JP) 2006-178163

(51) Int. Cl. B29C 65/48

(52) U.S. Cl. 156/391

(57) ABSTRACT

To provide an adhesive tape joining apparatus including: a pair of back and forth joining rollers which joins an adhesive tape to a main body that is moved and operated along a joining face of a workpiece by pressing the adhesive tape against the joining face and can be elastically transformed; a first guide roller engaged with a weather strip mounting groove, which is the outer face of the workpiece being different from the joining face at a front position of the joining roller; and a pair of back and forth second guide rollers which is engaged with a curved angular portion at the terminal end of the workpiece on the opposite side of the joining face.

### BACKGROUND OF THE INVENTION

(1) Field of the Invention

The present invention relates to an adhesive tape joining apparatus used when an adhesive tape is joined to a curved workpiece such as a door sash of an automobile.

(2) Description of the Related Art

In recent years, in a manufacturing process of an automobile, in place of black coating processing on a door sash, a technology to join a black adhesive tape has been developed. For example, an adhesive tape joining apparatus (an adhesive tape joining jig) has been suggested. Herein, an adhesive tape from which a separator is separated is elastically pressed against a tape joining face with a joining roller to be joined thereto while guiding and moving this adhesive tape joining apparatus on hand along a workpiece (refer to JP-A 2005-35724).

This apparatus is provided with a pair of back and forward guide rollers to be engaged in a weather strip as an engagement groove which is formed by an inside face that is a tape joining face of a workpiece and a rib which is formed being separated from a rear face of this inside face and a pair of back and forward side guide rollers to be engaged in an outer side face of this rib on its base. In addition, a tape joining face of the workpiece is sandwiched between an elastically deformable pair of back and forward joining rollers that are pivotally fitted to a spindle which is supported like a cantilever downward from the base and the pair of back and forward guide rollers so as to keep the posture of the adhesive tape joining apparatus with respect to the workpiece. Further, by engaging the side guide rollers from right and left of the workpiece, positioning in a right and left direction of the adhesive tape joining apparatus with respect to the workpiece is made.

Thus, the adhesive tape joining apparatus is moved along the workpiece with its position and its posture being determined due to the guidance of engagement by a roller group. The adhesive tape joining apparatus is configured in such a manner that, due to this movement, the adhesive tape is elastically pressed against the side face of the workpiece by an elastic roller arranged at the rear end of the base to be joined thereto.

However, the conventional apparatus has a lateral-outside terminal region floating from the opposite side of the joining face. Therefore, if there is a difference in level such as unevenness of a processing treatment due to welding on the bottom face of the weather strip engagement groove which is formed on the workpiece, the main body of the conventional apparatus falls down in a right and left oblique direction in a progress direction depending on how to put an operational force when getting over this difference in level and the joining roller tends to float from the joining face. In such a state, pressure of the joining roller with respect to the joining face runs short and this causes a defective joining.

In addition, it is necessary to advisedly carry out a forward movement operation while firmly imposing this apparatus on the bottom face of the workpiece in parallel. Accordingly, a joining speed tends to decelerate.

### SUMMARY OF THE INVENTION

The present invention has been made taking the foregoing problems into consideration and an object of which is to provide an adhesive tape joining apparatus that can carry out adhesive tape joining operation lightly and promptly by stably pressing a joining roller against a joining face of a workpiece.

In order to attain the aforementioned object, the present invention may include the following configuration:

An adhesive tape joining apparatus which supplies an adhesive tape to a joining roller winding the adhesive tape around the joining roller while moving forward the main body along a workpiece and joins this adhesive tape on a tape joining face of the workpiece by pressing the adhesive tape against the tape joining face, the apparatus comprising:

a first guide member which determines the position of the main body with respect to the workpiece being engaged with the outer face of the workpiece which is different from the tape joining face at a front position of the joining roller;

a tape supply roller for winding and guiding the supplied adhesive tape to introduce it to the joining roller;

a separator guide which is arranged being opposed to the tape supply roller;

a joining roller which joins the supplied adhesive tape to the main body that is moved and operated along the tape joining face by pressing the adhesive tape against the tape joining face and can be elastically transformed; and

a second guide member, in which a concavely-curved guide groove to be engaged with a convex portion, which is formed on the workpiece portion elongated from the rear face side of the joining face to lateral outside, is formed.

According to the adhesive tape joining apparatus of the present invention, two places of the region which faces lateral outside from the rear face side of the joining face which is the outer face different from the joining face are supported by the first guide member and the second guide member being contacted therewith. In other words, the posture of the apparatus with respect to a width direction of the workpiece can be easily stabilized. In addition, in the process for joining the adhesive tape on the workpiece by means of this apparatus, even if a force from a right and left oblique upper direction in the work width direction of this apparatus is given and the first guide member goes on a difference in level such as unevenness of a processing treatment due to welding, the second guide member is engaged with a convex portion formed on the workpiece, so that the main body of the apparatus does not fall horizontally. As a result, a rolling face of the joining roller is firmly pressed against the tape joining face, so that lack of joining due to lack of pressure of the joining roller is not caused.

The convex portion formed on the workpiece portion is an angular portion which is curved and formed at a terminal end in lateral outside of the workpiece. The second guide member is preferably a guide roller having a concavely-curved guide groove to be engaged with the angular portion formed on a rolling face. More preferably, a plurality of the guide rollers are arranged along a moving direction of the main body.

According to this configuration, since the guide roller is engaged to the angular portion where the second guide member is located outside the first guide member, so that it is possible to prevent falling of the main body of the apparatus due to a force given from an upward direction of the outside of the apparatus into an oblique downward direction.

In addition, for example, the main body of this apparatus can be configured as follows.

The main body comprises:

a first bracket which is shaped in a block;

a second bracket which is arranged downward being at a right angle to one end portion of the first bracket;

a movable bracket which is swingably supported by the first bracket around a support point directed in a back and forth direction so as to be opposed to the second bracket; and

a third bracket which is arranged downward substantially being at a right angle to another end portion of the first bracket. The joining roller is mounted on a fixed core shaft so as to be capable of freely idling which is connected to the first bracket so as to be opposed to the third bracket across the workpiece.

It is preferable that the apparatus is configured so that

the first guide member is mounted on the main body being fixed at a predetermined position thereof and the second guide member is mounted on the movable bracket mounted on the main body; and

the movable bracket having the second guide member mounted thereon is biased to the convex portion side which is formed on the workpiece by an elastic body.

The elastic body is, for example, a compression coil spring which is intervened between the third bracket and the movable bracket; and the compression coil spring to swingably bias the movable bracket is configured to be accepted by a screw which is mounted on the third bracket side.

According to this configuration, since the second guide member is elastically biased toward the angular portion which is formed on the workpiece, the posture of the apparatus with respect to the width direction of the workpiece can be easily stabilized.

As a result, according to this apparatus, even if the apparatus which is engaged and mounted to the workpiece is made to move forward without discretion, by swinging the movable bracket, which is capable of smoothly and securely joining the adhesive tape without causing insufficient pressure, receding against a biasing force, it is possible to cover the workpiece with the convex portion and the second guide member being spaced each other. As a result, the apparatus can be easily mounted on the workpiece.

In addition, in the apparatus, the movable bracket may be configured so that a movement limitation position in a bias direction is varied and adjusted.

According to this configuration, setting corresponding to a measurement and a specification of the workpiece is allowed, so that its general versatility is increased.

In addition, this apparatus may be configured so as to be capable of varying and adjusting a bias force by the elastic body.

According to this configuration, in response to the measurement and the specification of the workpiece and a kind of the adhesive tape or the like, it is possible to properly adjust a pressing force of the joining roller against the workpiece.

The joining roller is preferably configured to have an elastic layer on its surface.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a perspective view of an adhesive tape joining apparatus which is mounted on a workpiece;

FIG. 2 is a partially notched front view of the adhesive tape joining apparatus which is mounted on the workpiece;

FIG. 3 is a perspective view of the adhesive tape joining apparatus seen from other direction;

FIG. 4 is a cross sectional plan view of the adhesive tape joining apparatus;

FIG. 5 is a partially notched front view showing the adhesive tape joining apparatus according to other embodiment; and

FIG. 6 is a partially notched front view showing the adhesive tape joining apparatus according to other embodiment.

### DESCRIPTION OF THE PREFERRED EMBODIMENTS

Hereinafter, an embodiment of the present invention will be described with reference to the drawings.

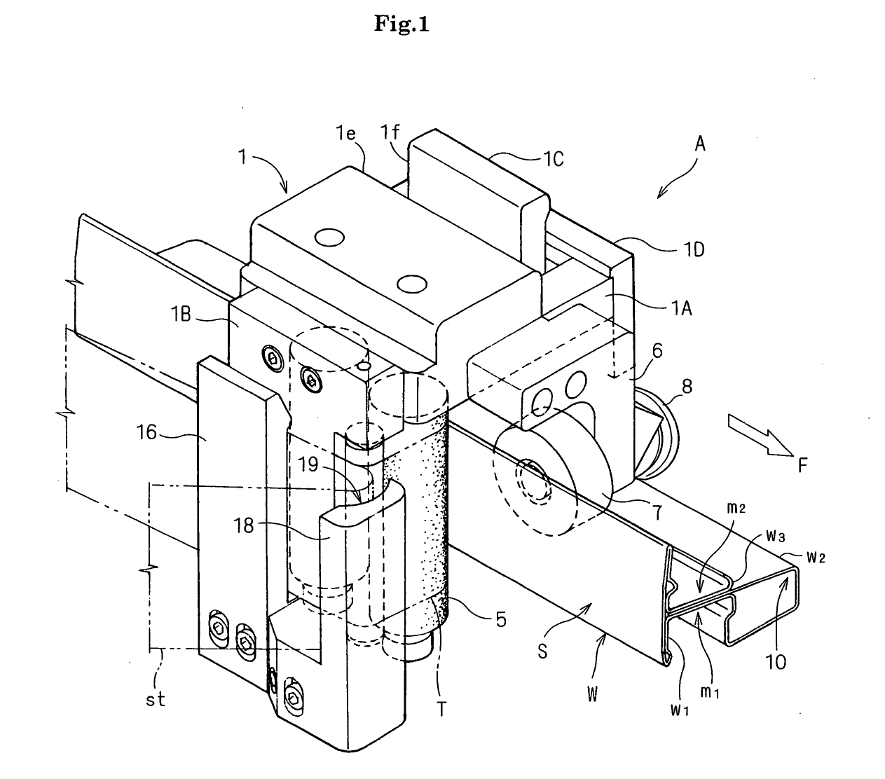

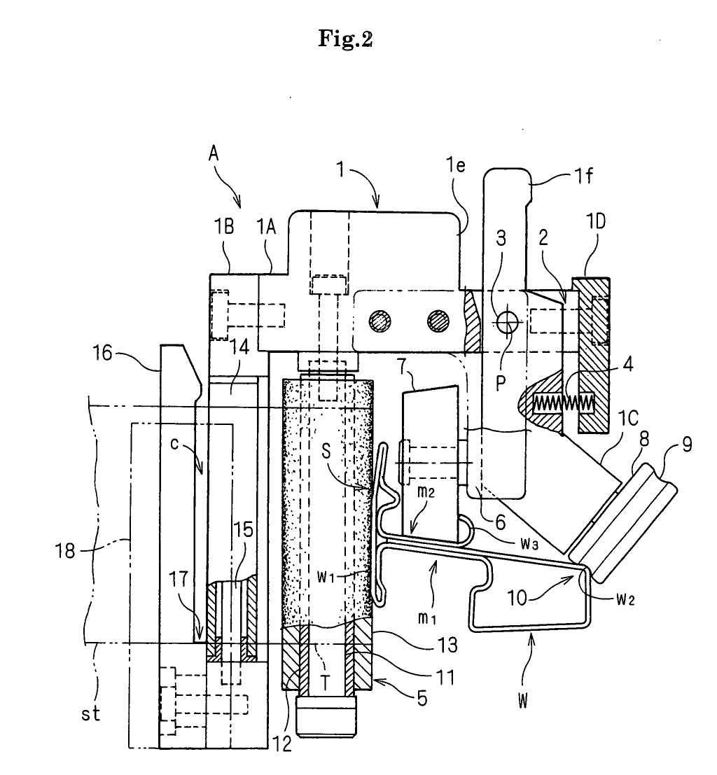

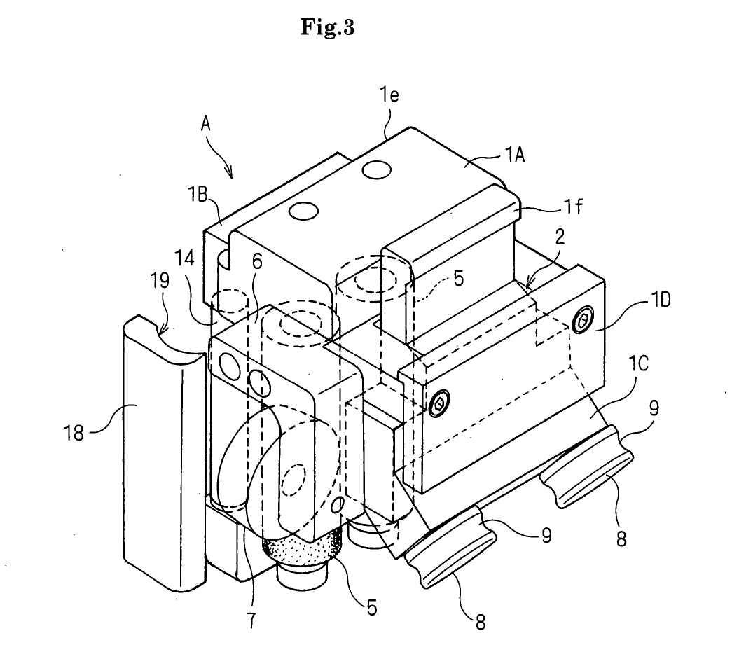

FIG. 1 is a perspective view of an adhesive tape joining apparatus A which is mounted on a workpiece, FIG. 2 is a front view of the adhesive tape joining apparatus A which is mounted on the workpiece, and FIG. 3 is a perspective view of the adhesive tape joining apparatus A seen from the opposite side.

Further, a workpiece W according to the present embodiment is a door sash of an automobile, and a black adhesive tape is joined to the outer side face of the workpiece W in place of black coating.

The workpiece W is configured by press polymerization of a single steel plate. This workpiece W has an outer frame w1 shaped in a longitudinal wall at the lateral outside that is the outer face of the door of the work W, and the workpiece W is formed with a cross section that a hollow lateral frame w2 thrusting from this outer frame w1 toward the inside of the door (the right side in FIG. 2) is connected. Then, between a hollow region of the lateral frame w2 and the outer frame w1, a window glass mounting groove m1 is formed being directed downward. In addition, at right and left middle region of the upper face of the lateral frame w2, a rib w3 is protruded along the longitudinal direction of the workpiece. Between this rib w3 and the outer frame w1, a weather strip mounting groove m2 is formed being directed upward. Then, the outer face at the outer frame w1 (the left outer lateral side in FIG. 2) becomes a tape joining face S. On this tape joining face S, an adhesive tape T is joined by using an adhesive tape joining apparatus A according to the present invention. As the adhesive tape T, an adhesive tape with a separator that is wider than the tape joining face S is used.

The apparatus A may join the adhesive tape T being guided and engaged to the workpiece W while moving forward along the workpiece longitudinal direction by the manual labor. In the following description, as a matter of convenience, a direction F of joining and moving the adhesive tape joining apparatus A is called as a front direction, and door inside and outside directions that are perpendicular to the tape joining direction are called as a lateral direction or a right and left direction.

A main body 1 of this apparatus A is formed by a hard resin material. As shown in FIG. 1 and FIG. 2, the main body 1 is configured by a first bracket 1A shaped in an angular block, a second bracket 1B that is coupled by a bolt to be perpendicular downward to one end of this first bracket 1A, a movable bracket 1C that is supported to the first bracket 1A capable of swinging around a support point p directed in back and front directions so as to be opposed to the second bracket 1B, and a third bracket 1D that is connected to the other end of the first bracket 1A through a bolt being substantially downwardly perpendicular thereto.

The movable bracket 1C is pivotally connected to the first bracket 1A capable of swinging in a lateral direction around the support point p via a support shaft 3 being inserted in an opening 2 formed penetrating the first bracket 1A upward and downward. In addition, the movable bracket 1C is swingably biased in a direction separated from the third bracket 1B by a compression coil spring 4 intervened between the movable bracket 1C and the third bracket 1D.

On the lower face at one end of the first bracket 1A, a pair of back and forth joining rollers 5 that can freely idle around a longitudinal axial core is mounted downward like a cantilever being supported by a shaft. In addition, on a fixed bracket 6 that is connected to the front end face of the first bracket 1A through a bolt, as the first guide member, a single first guide roller 7 capable of idling around is mounted being supported by a shaft around the lateral axial core.

The first guide roller 7 is formed by a hard resin material excellent in smoothness in a slightly taper shape. Then, this guide roller 7 is inserted and engaged in a weather strip mounting groove m2 at the workpiece W to be guided and rolled along its groove bottom face.

In addition, the lower portion of the movable bracket 1C is obliquely curved toward the outside. On the lower end face of this movable bracket 1C, as shown in FIG. 2, as the second guide member, a pair of back and forward second guide rollers 8 is mounted freely idling around a longitudinal axial core being supported by a shaft.

The second guide roller 8 is formed by a hard resin material excellent in smoothness similarly to the first guide roller 7. In addition, the outer circumferential face of this guide roller 8 contacts an angular portion 10 with pressure, which is curved at the outer terminal end of the workpiece. In addition, on the outer circumferential face of the second guide roller 8, a guide groove 9, which is shallowly concave curved in accordance with the angular portion 10, is formed circularly. This guide groove 9 is engaged with the angular portion 10. Therefore, the second guide roller 8 moves stably along the angular portion 10 while rolling.

In this way, the fixed first guide roller 7 is engaged with the weather strip mounting groove m2 on the rear face side of the joining face S and the movable second guide roller 8 is engaged with the angular portion 10 which is curved at the outer terminal end of the workpiece W at a distance from the first guide roller 7. Thereby, the posture of the apparatus A is kept.

The joining roller 5 is configured in such a manner that a tubular axis 12 is externally fitted to a fixed core axis 11 coupled to the first bracket 1A so as to freely idle and this tubular axis 12 is coated with a sponge-like elastic layer 13. In other words, in the case that the apparatus A is engaged at a predetermined position and a predetermined posture with respect to the workpiece W, the joining roller 4 is pressed against the joining face S while being elastically transformed in moderation.

At the front end of the second bracket 1B, a tape supply roller 14 is supported by a shaft around a longitudinal axial core freely idling so as to be opposed to the joining roller 5 at the front side in parallel. This tape supply roller 14 is formed by a hard resin material excellent in smoothness and is supported by a fixed support shaft 15 to freely fit.

In addition, a platy tape guide 16 formed by a hard resin material is attached and fixed on the lower part of the outer face of the second bracket 1B, and between this tape guide 16 and the outer side face of the second bracket 1B, a tape insertion gap c released back and force and upward is formed. A bottom end of the tape insertion gap c becomes a tape positioning part 17. When the lower side edge of the adhesive tape T inserted in this tape insertion gap c is accepted and supported by the tape positioning part 17, positioning of the adhesive tape T is carried out in a width direction. Further, the tape guide 16 is attached in an upper and lower direction, namely, in a tape width direction so that its position can be adjusted.

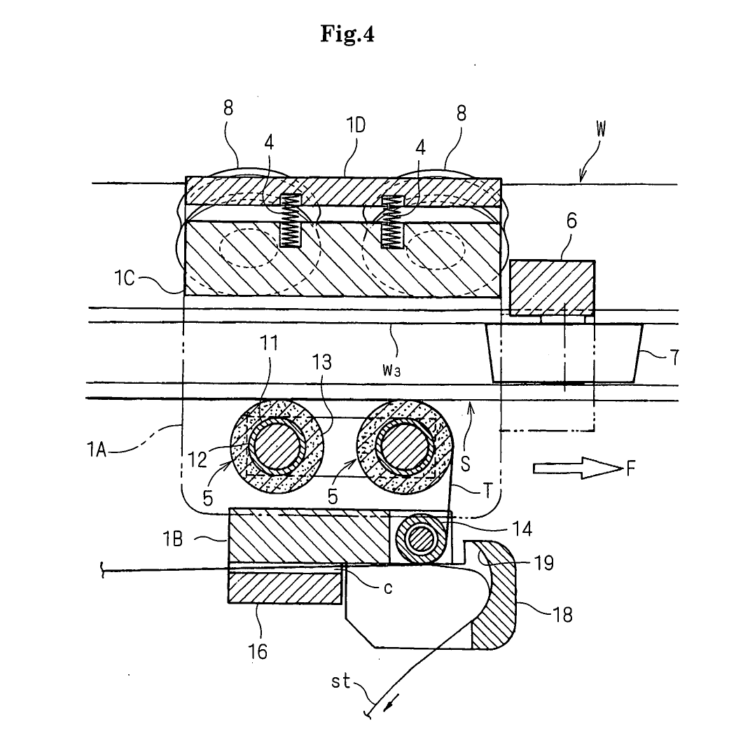

In addition, at the front end side of the lower part of the outer side face in the second bracket 1B, a separator guide 18 made of a hard resin material is attached and fixed. This separator guide 18 is arranged at the front position of the tape supply roller 14 to be opposed to the tape supply roller 14 with an appropriate interval, and further, is arranged slightly lower than the tape supply roller 14. As shown in FIG. 1, FIG. 3, and FIG. 4, a separator guide face 19 that is concave-curved opposed to the tape supply roller 14 is formed at a backward face of this separator guide 18 so as to be opposed to the tape supply roller 14. This separator guide 18 is also attached in an upper and lower direction, namely, in a tape width direction so that its position can be adjusted.

The adhesive tape joining apparatus A according to the present invention is configured as described above. Next, a step to apply the adhesive tape T on the workpiece W by using the apparatus A of the above-described embodiment will be described below.

First, an operator covers the workpiece W with the movable bracket 1C while enlarging a gap between the joining roller 5 and the second guide roller 8 by swinging the movable bracket 1C against the compression coil spring 4, and the first guide roller 7 is engaged in the weather strip mounting groove m2 on the upper face of the workpiece. After that, by freely biasing and swinging the movable bracket 1C, the workpiece W is elastically sandwiched from right and left by the second guide roller 8 and the joining roller 5. Further, using a boss portion 1e formed on the upper face of the second bracket 1B shown from FIG. 1 to FIG. 3 as a support of fingers, drawing a finger hanging part if elongated upward from the movable bracket 1C to the side of the boss portion 1e, it is possible to swing the movable bracket 1C by one hand.

Next, after inserting the adhesive tape T with a separator through the tape insertion gap c so that its separator st is located at the lateral outer side, by peeling off the separator st from the front end of the adhesive tape T, the adhesive face is exposed. Winding and guiding the adhesive tape T by means of the tape supply roller 14, the adhesive tape T is pasted on a predetermined position of the tape joining face S to be temporarily jointed. In this case, at a tape winding region of the tape supply roller 14, the separator st peeled off from the adhesive tape T is guided by the separator guide face 19 of the separator guide 18 to be guided to the rear outside.

After that, by winding the adhesive tape T by the joining roller 5, the adhesive tape T is elastically pressed against the joining face S. In this state, the apparatus A is manually moved along the workpiece W to the front side F, and thereby, it is possible to continuously paste the adhesive tape T on the tape joining face S while positioning the adhesive tape T in a width direction.

In this case, moving the adhesive tape joining apparatus A to the front side F, when the adhesive tape T is moved relatively to the front side F, the separator st is guided being reversed on the separator guide face 19 of the separator guide 18 to be fed in a direction separated from the joining roller 5. Accordingly, even in the case of joining the adhesive tape T while moving the apparatus A upward or downward at the longitudinal portion of the workpiece W, it is possible to prevent the separated separator st from being involved in the adhesive tape T to come close to the tape joining face S or from interrupting the forward movement of the apparatus A in advance.

Further, upper and lower protruding portions of the adhesive tape T that is pasted on the joining face S are pasted being involved in the peripheral portion of the lateral frame w2 in a later step.

Further, in the case that there is a difference in level such as unevenness of a processing treatment due to welding on the bottom face of the weather strip engagement groove m2, the main body of the apparatus tends to fall down outward differently from the tape joining face when the first guide roller 7 gets over this difference in level depending on how to give the force to the main body of the apparatus. In such a case, since the second guide roller 8 supports the main body of the apparatus being always engaged with the angular portion 10 of the workpiece W accepting the spring bias force of the mounted movable bracket 1C, the main body of the apparatus is prevented from falling down. As a result, even if the apparatus A is moved forward without discretion in a manual fashion, it is possible to reliably carry out the adhesive tape joining smoothly and speedy without lack of pressure by the joining roller 5.

The present invention is not limited to the above-described embodiments and it can be practiced being modified as described below.

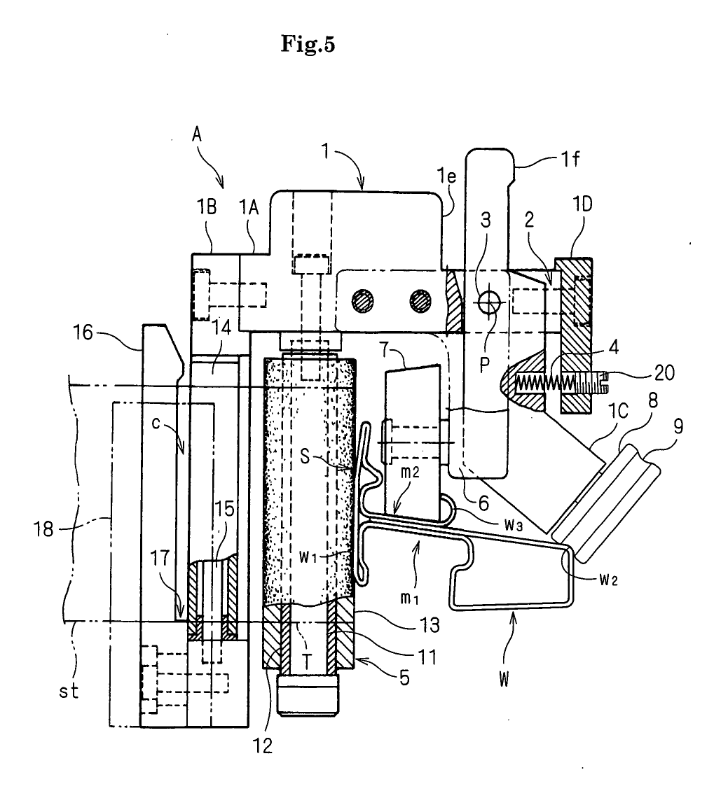

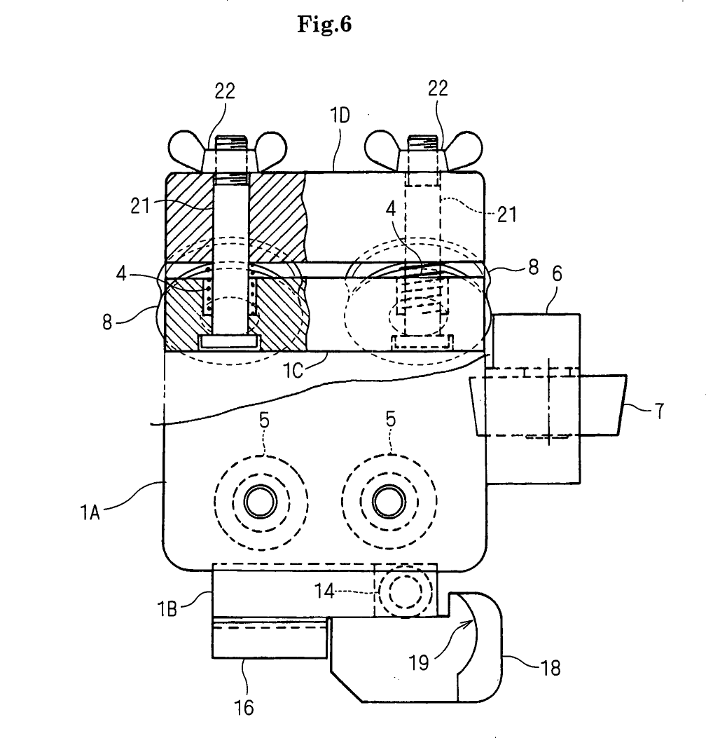

(1) According to the above-described embodiment, the second guide roller 8 which is the second guide member is engaged with the angular portion 10 of the workpiece as the convex portion. However, the convex portion is not limited to the angular portion 10 and may be other convex portions to be formed on the upper face of the lateral frame w2. In this case, the closer the convex portion to be formed is to the terminal end side of the lateral frame w2, the better. Such a configuration can stabilize traveling of the main body when operating the apparatus according to the above-described embodiments.
(2) As shown in FIG. 5, if the present invention is configured so that the end portion at the fixed side of the compression coil spring 4 to swing and bias the movable bracket 1C is accepted by a spring 20 that is mounted on the third bracket 1D, a spring load may be adjusted by adjusting forward and backward movement of the spring 20 so as to adjust swinging bias force to be given to the movable bracket 1C. In other words, the elastic pressing force to the workpiece W of the second guide roller 8 can be varied and adjusted.
(3) As shown in FIG. 6, the movable bracket 1C is slidably supported by a pair of back and forth rods with a head 21 mounted on the movable bracket 1C in a lateral direction. Further, the present invention can also be practiced in such a manner that the movable bracket 1C is slidably biased so as to be in parallel with the side of the joining roller 5 by the compression coil spring 4 externally fitted to the rod 21. In this case, by adjusting and operating a nut 22 which is fitted at the external end portion of the rod 21 to adjust the head position of the rod 21 right and left, the initial position of the movable bracket 1C can be adjusted. In other words, the initial position of the second guide roller (the second guide member) 8 can be adjusted.
(4) Other than the case of using the compression coil spring 4 as an elastic body to bias and bring the movable bracket 1C close to the side of the joining roller 5, a rubber material can also be used. In addition, in the configuration to swingably support the movable bracket 1C, a twisting spring externally fitted to the support shaft 3 can also be used as an elastic body to bias and bring the movable bracket 1C close to the side of the joining roller 5.

### (5) By engaging at least one of the first guide member 7 or the second guide member 8 to the workpiece W, the present embodiment can also be configured by a guide block made of a hard resin material excellent in smoothness to slide and move.

(6) According to the above-described embodiments, the second guide roller 8 to be engaged with the angular portion 10 of the workpiece W may be a single or a plurality not less than two. In addition, the second guide member is not limited to the second guide roller 8, and any configuration in which the second guide member can slide to the convex portion is acceptable.

The present invention may be embodied in other specific forms without departing from the spirit or essential attributes thereof and, accordingly, reference should be made to the appended claims, rather than to the foregoing specification, as indicating the scope of the invention.

What is claimed is:

1. An adhesive tape joining apparatus which supplies an adhesive tape to a joining roller winding the adhesive tape around the joining roller while moving forward the main body along a workpiece and joins this adhesive tape on a tape joining face of the workpiece by pressing the adhesive tape against the tape joining face, the apparatus comprising:
a first guide member which determines the position of the main body with respect to the workpiece being engaged with the outer face of the workpiece which is different from the tape joining face at a front position of the joining roller;
a tape supply roller for winding and guiding the supplied adhesive tape to introduce it to the joining roller;
a separator guide which is arranged being opposed to the tape supply roller;
a joining roller which joins the supplied adhesive tape to the main body that is moved and operated along the tape joining face by pressing the adhesive tape against the tape joining face and can be elastically transformed; and
a second guide member, in which a concavely-curved guide groove to be engaged with a convex portion, which is formed on the workpiece portion elongated from the rear face side of the joining face to lateral outside, is formed.

2. The adhesive tape joining apparatus according to claim 1, wherein
the convex portion is an angular portion which is curved and formed at a terminal end in lateral outside of the workpiece; and
the second guide member is a guide roller having a concavely-curved guide groove to be engaged with the angular portion formed on a rolling face.

3. The adhesive tape joining apparatus according to claim 2, wherein
a plurality of the guide rollers are arranged along a moving direction of the main body.

4. The adhesive tape joining apparatus according to claim 1, wherein
the main body comprising:
a first bracket which is shaped in a block;
a second bracket which is arranged downward being at a right angle to one end portion of the first bracket;
a movable bracket which is swingably supported by the first bracket around a support point directed in a back and forth direction so as to be opposed to the second bracket; and
a third bracket which is arranged downward substantially being at a right angle to another end portion of the first bracket;
wherein
the joining roller is mounted on a fixed core shaft so as to be capable of freely idling which is connected to the first bracket so as to be opposed to the third bracket across the workpiece.

5. The adhesive tape joining apparatus according to claim 1, wherein
the first guide member is mounted on the main body being fixed at a predetermined position thereof and the second guide member is mounted on the movable bracket mounted on the main body; and
the movable bracket having the second guide member mounted thereon is biased to the convex portion side which is formed on the workpiece by an elastic body.

6. The adhesive tape joining apparatus according to claim 5, wherein
the elastic body is a compression coil spring which is intervened between the third bracket and the movable bracket; and
the compression coil spring to swingably bias the movable bracket is configured to be accepted by a screw which is mounted on the third bracket side.

7. The adhesive tape joining apparatus according to claim 5, wherein
the movable bracket is configured so that a movement limitation position in a bias direction can be varied and adjusted.

8. The adhesive tape joining apparatus according to claim 5, which is configured so as to be capable of varying and adjusting a bias force by the elastic body.

9. The adhesive tape joining apparatus according to claim 1, wherein
the joining roller is configured to have an elastic layer on its surface.
